(19) United States
(12) Patent Application Publication
(10) Pub. No.: US 2026/0147166 A1
(43) Pub. Date: May 28, 2026

(54) PHOTONIC PACKAGING STRUCTURE AND MANUFACTURING METHOD THEREOF

(71) Applicant: AUO Corporation, Hsinchu City (TW)

(72) Inventors: Chung-Tao CHEN, Hsinchu City (TW); Yang-En WU, Hsinchu-City (TW); Sung-Yu SU, Hsinchu City (TW)

(21) Appl. No.: 19/385,197

(22) Filed: Nov. 11, 2025

(30) Foreign Application Priority Data
Nov. 28, 2024 (TW) 113146136

(51) Int. Cl. G02B 6/42

(52) U.S. Cl. CPC G02B 6/4214; G02B 6/4245

(57) ABSTRACT

A photonic packaging structure includes a substrate, a silicon photonic module, a light-emitting diode module, and a driving element. The silicon photonic module has a first surface connected to the substrate and a second surface opposite the first surface. The light-emitting diode module is connected to the second surface, such that the silicon photonic module is positioned between the substrate and the light-emitting diode module. The light-emitting diode module includes a carrier, at least one light-emitting diode element, and at least one conductive bump. The light-emitting diode element is disposed on the carrier and faces the silicon photonic module. The conductive bump is also disposed on the carrier, faces the substrate, and is electrically connected to the light-emitting diode element. The driving element is disposed on the substrate and electrically connected to the conductive bump.

### CROSS-REFERENCE TO RELATED APPLICATION

This application claims priority to Taiwan Application Serial Number 113146136, filed November 28, 2024, which is herein incorporated by reference in its entirety.

### BACKGROUND

### Field of Invention

The present invention relates to a photonic packaging structure and a manufacturing method thereof. More particularly, the present invention relates to a photonic packaging structure and a manufacturing method thereof, which can prevent high temperatures from adversely affecting the service life.

### Description of Related Art

As the scale of artificial intelligence models continues to grow, especially with the increased computing power of large language models (LLMs), the demand for high-bandwidth transmission is rapidly increasing. Consequently, conventional electronic transmission methods are unable to meet the massive data processing requirements, necessitating the reliance on optical transmission technology. Silicon photonic modules, which enable high-speed and efficient data exchange, have become a key area of development.

However, the light source of silicon photonic modules is usually a laser diode. Laser diodes can provide high-intensity optical signals, but they generate significant heat during operation, which causes the overall temperature to rise. This temperature increase leads to attenuation of the laser diodes’ light intensity and may even damage the device, thereby adversely affecting the lifespan and performance of the silicon photonic module.

In view of the foregoing, improving the high-temperature problem of conventional silicon photonic modules has become an important goal in the related industry.

### SUMMARY

The purpose of the present disclosure is to provide a photonic packaging structure and a manufacturing method thereof, which can reduce the heating problem of light-emitting modules by replacing the light-emitting source, thereby extending the service life of the photonic packaging structure.

One embodiment of the present disclosure provides a photonic packaging structure. The photonic packaging structure includes a substrate, a silicon photonic module, a light-emitting diode (LED) module, and a driving element. The silicon photonic module has a first surface and a second surface opposite to each other, with the first surface connected to the substrate. The light-emitting diode module is connected to the second surface of the silicon photonic module, such that the silicon photonic module is positioned between the substrate and the light-emitting diode module. The light-emitting diode module includes a carrier, at least one light-emitting diode element, and at least one conductive bump. The light-emitting diode element is disposed on the carrier and faces the silicon photonic module. The conductive bump is also disposed on the carrier, faces the substrate, and is electrically connected to the light-emitting diode element. The driving element is disposed on the substrate and is electrically connected to the conductive bump.

Accordingly, the photonic packaging structure disclosed herein provides a stable and efficient light-emitting performance by using a light-emitting diode module. This configuration can prevent temperature rise within the photonic packaging structure, thereby reducing problems such as light intensity attenuation or structural damage caused by high temperatures, and thus extending the service life of the photonic packaging structure.

According to the aforementioned photonic packaging structure, the silicon photonic module may include a grating, and the light-emitting diode element may be aligned with the grating.

According to the aforementioned photonic packaging structure, the silicon photonic module may further include a modulation element and a waveguide element. The modulation element may be coupled to the waveguide element, and the waveguide element may be connected to the grating.

According to the aforementioned photonic packaging structure, the number of light-emitting diode elements may be plural, and the light-emitting diode elements may be electrically connected in parallel.

According to the aforementioned photonic packaging structure, the photonic packaging structure may further include two pads disposed on the carrier of the light-emitting diode module. The two pads may be connected in parallel to the light-emitting diode elements.

According to the aforementioned photonic packaging structure, the substrate may include at least one connecting bump, and the conductive bump may be connected to the connecting bump.

According to the aforementioned photonic packaging structure, the silicon photonic module may include a conductive portion, and the conductive bump may be connected to the conductive portion.

According to the aforementioned photonic packaging structure, the photonic packaging structure may further include at least one optical fiber interface, and the optical fiber interface may be connected to the silicon photonic module.

According to the aforementioned photonic packaging structure, the photonic packaging structure may further include a light-concentrating element. The light-concentrating element may be disposed between the silicon photonic module and the light-emitting diode module.

According to the aforementioned photonic packaging structure, the substrate may include a conductive via, and the conductive via may electrically connect two opposite sides of the substrate.

One embodiment of the present disclosure provides a method for manufacturing a photonic packaging structure, which includes the following steps. A silicon photonic module is disposed on a substrate, wherein the silicon photonic module has a first surface and a second surface opposite to each other, and the first surface is connected to the substrate. At least one light-emitting diode element and at least one conductive bump are disposed on a carrier, and the conductive bump is electrically connected to the light-emitting diode element to form a light-emitting diode module. The light-emitting diode module is then connected to the second surface of the silicon photonic module such that the silicon photonic module is positioned between the substrate and the light-emitting diode module. The light-emitting diode element of the light-emitting diode module faces the silicon photonic module, and the conductive bump faces the substrate. A driving element is disposed on the substrate, and the conductive bump is electrically connected to the driving element to obtain the photonic packaging structure.

According to the aforementioned method for manufacturing the photonic packaging structure, the substrate may include at least one connecting bump, and the driving element may be electrically connected to the conductive bump through the connecting bump.

One embodiment of the present disclosure provides a method for manufacturing a photonic packaging structure, which includes the following steps. A plurality of silicon photonic modules are disposed on a base material. A plurality of light-emitting diode elements and a plurality of conductive bumps are disposed on a carrier, wherein the conductive bumps are electrically connected to the corresponding light-emitting diode elements, thereby forming a plurality of light-emitting diode modules on the carrier. The base material having the silicon photonic modules is then connected to the carrier having the light-emitting diode modules such that the silicon photonic modules and the light-emitting diode modules are located between the base material and the carrier. The light-emitting diode modules are respectively connected to the corresponding silicon photonic modules to form a pre-dicing structure, wherein the light-emitting diode elements of the light-emitting diode modules face the silicon photonic modules, and the conductive bumps face the base material. The pre-dicing structure is then diced to form a plurality of composite module structures. One of the composite module structures and a driving element are disposed on a substrate, and the driving element is electrically connected to the conductive bump of one of the composite module structures to obtain the photonic packaging structure.

According to the aforementioned method for manufacturing the photonic packaging structure, each silicon photonic module may include a conductive portion, and the conductive bump of the light-emitting diode module may be connected to the conductive portion.

According to the aforementioned method for manufacturing the photonic packaging structure, a filler may be introduced between the base material and the carrier before dicing the pre-dicing structure.

It is to be understood that both the foregoing general description and the following detailed description are presented by way of example and are intended to provide further explanation of the invention as claimed.

### BRIEF DESCRIPTION OF THE DRAWINGS

The invention can be more fully understood by reading the following detailed description of the embodiments, with reference to the accompanying drawings as follows:

FIG. 1 is a cross-sectional view of a photonic packaging structure according to a first embodiment of the present disclosure.

FIG. 2A is a schematic top view of the photonic packaging structure shown in FIG. 1.

FIG. 2B is a schematic bottom view of the photonic packaging structure shown in FIG. 1.

FIG. 3A is a schematic cross-sectional view of a silicon photonic module of the photonic packaging structure shown in FIG. 1.

FIG. 3B is a schematic top view of the silicon photonic module of the photonic packaging structure shown in FIG. 1.

FIG. 4 is a schematic diagram illustrating the arrangement of light-emitting diode elements in the photonic packaging structure shown in FIG. 1.

FIG. 5 is a schematic cross-sectional view of a photonic packaging structure according to a second embodiment of the present disclosure.

FIG. 6 is a schematic cross-sectional view of a photonic packaging structure according to a third embodiment of the present disclosure.

FIG. 7A is a schematic front view of an optical signal switching module according to an embodiment of the present disclosure.

FIG. 7B is a schematic top view of the optical signal switching module shown in FIG. 7A.

FIG. 8A is a signal conversion schematic diagram of the photonic packaging structure of the present disclosure.

FIG. 8B is another signal conversion schematic diagram of the photonic packaging structure of the present disclosure.

FIG. 9 is a flowchart illustrating a method for manufacturing a photonic packaging structure according to another embodiment of the present disclosure.

FIGS. 10A-10F are structural schematic diagrams showing respective steps in the method for manufacturing the photonic packaging structure.

FIG. 11 is a flowchart illustrating a method for manufacturing a photonic packaging structure according to another embodiment of the present disclosure.

FIGS. 12A-12H are structural schematic diagrams showing respective steps in the method for manufacturing the photonic packaging structure.

### DETAILED DESCRIPTION

Reference will now be made in detail to the present embodiments of the invention, examples of which are illustrated in the accompanying drawings. Wherever possible, the same reference numerals are used in the drawings and the description to refer to the same or similar parts. However, the specific structural and functional details disclosed herein are merely representative for purposes of describing example embodiments and may be embodied in many alternate forms. They should not be construed as limited to the example embodiments set forth herein. Therefore, it should be understood that there is no intent to limit the example embodiments to the particular forms disclosed. On the contrary, the example embodiments are intended to cover all modifications, equivalents, and alternatives falling within the scope of the invention.

In addition, when a component (or mechanism, module, etc.) is described as being "connected," "disposed," or "coupled" to another component, it may mean that the component is directly connected, directly disposed, or directly coupled to the other component, or it may mean that the component is indirectly connected, indirectly disposed, or indirectly coupled to the other component, that is, with another component interposed therebetween. Only when it is explicitly stated that a component is "directly connected," "directly disposed," or "directly coupled" to another component does it mean that no other component is interposed between them.

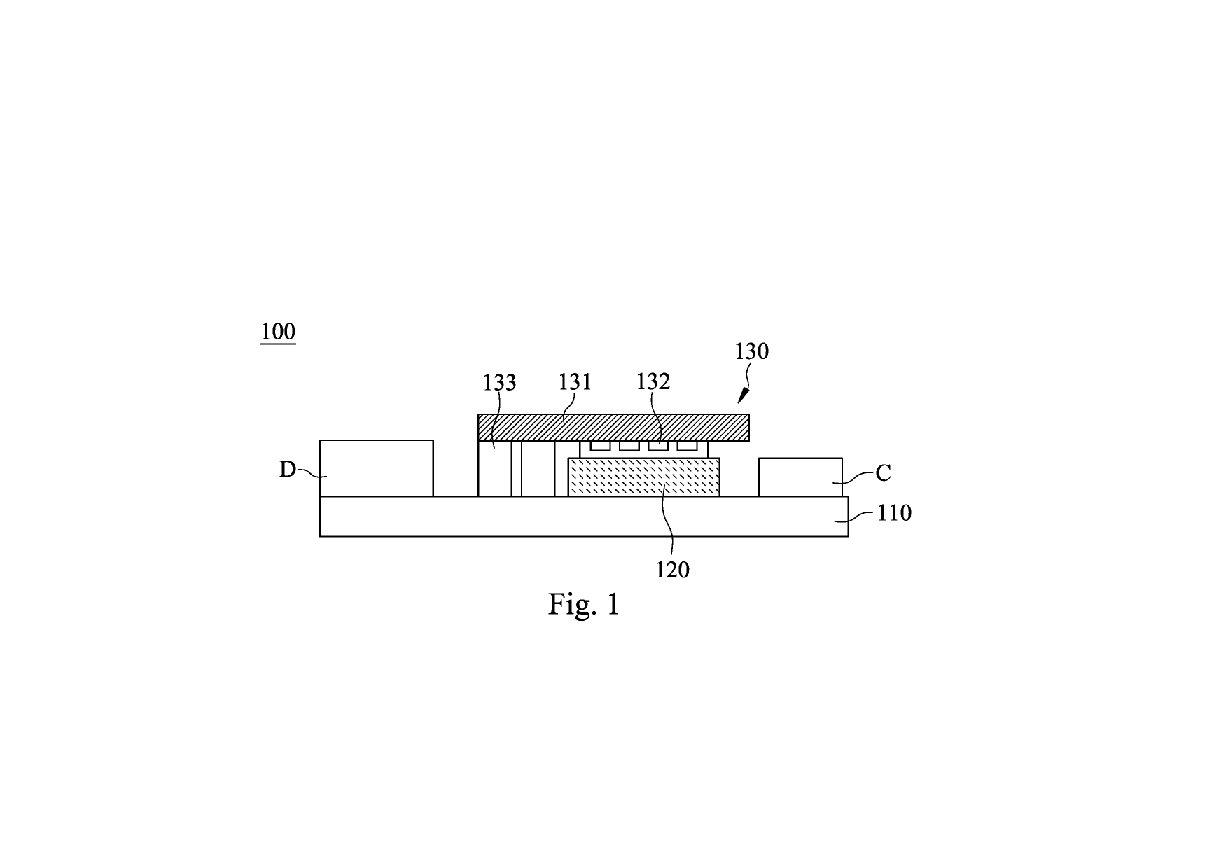

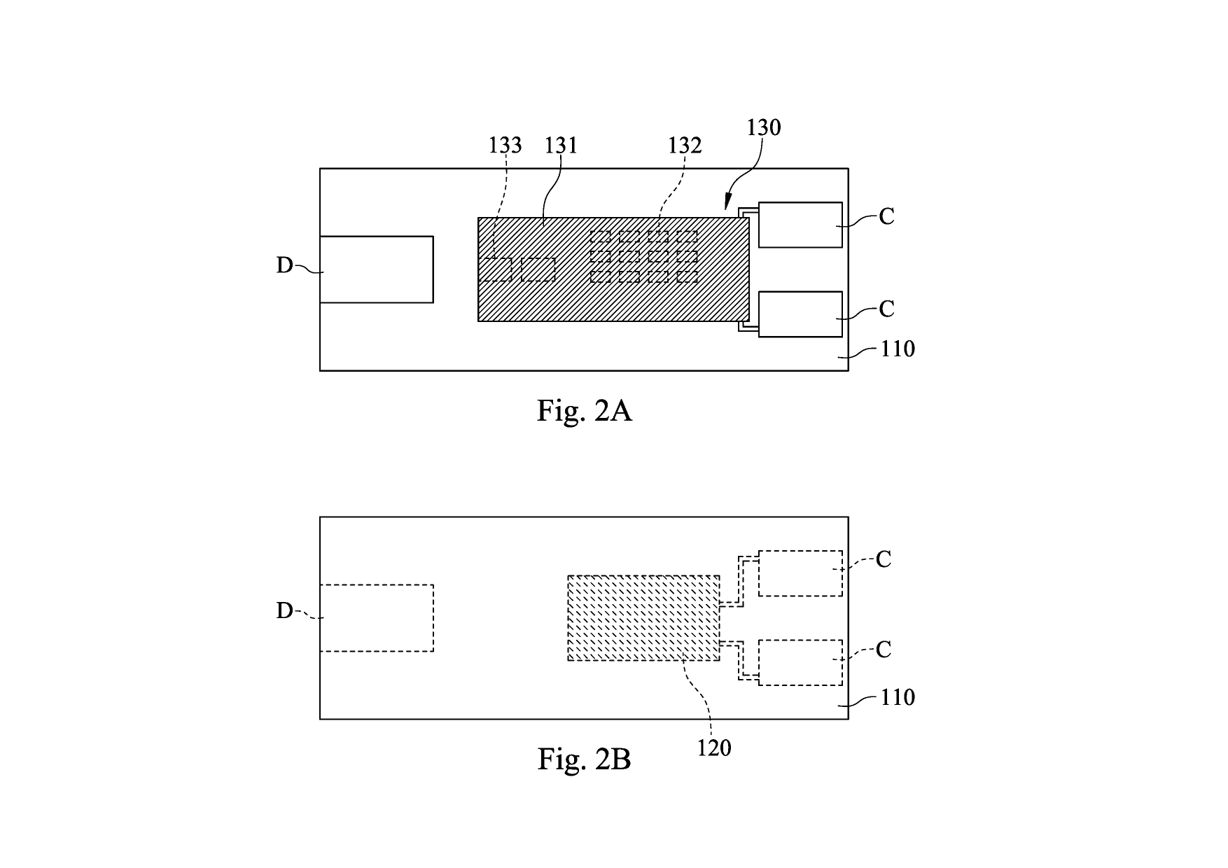

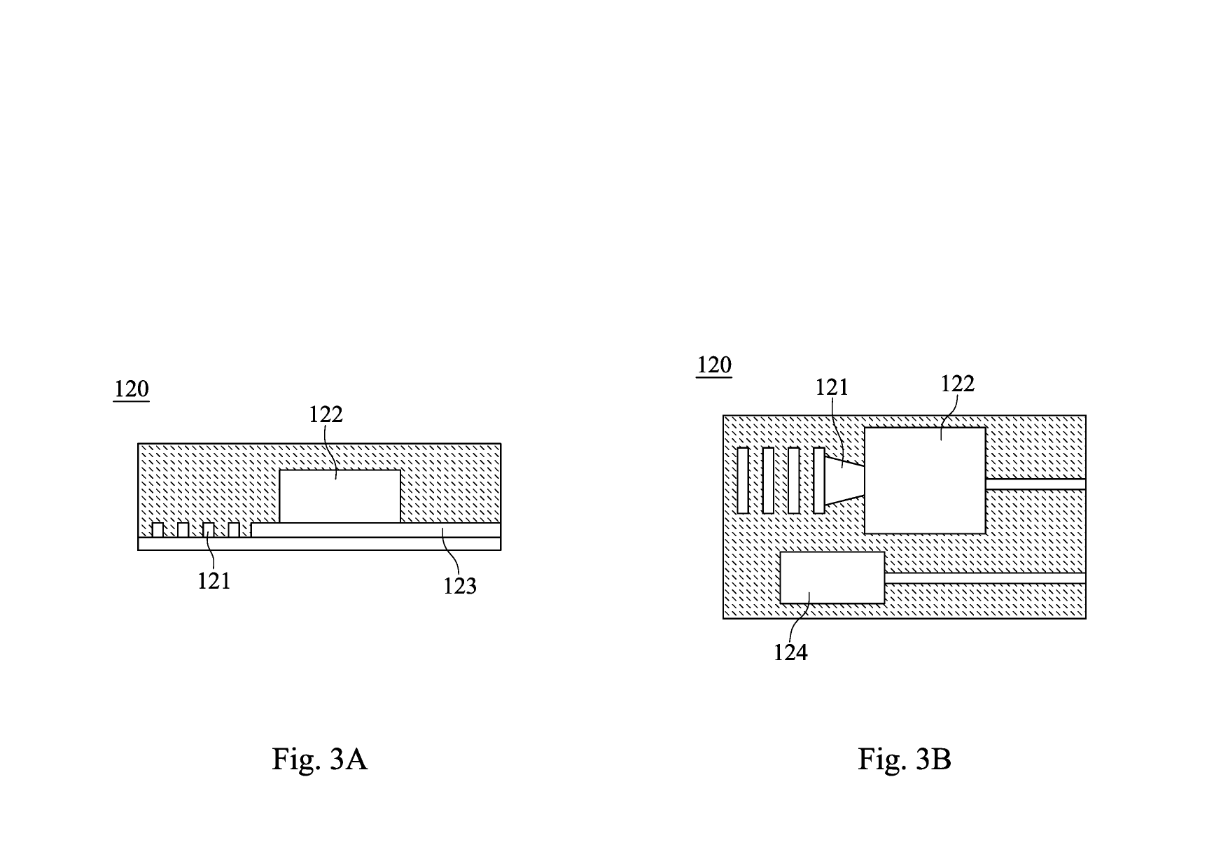

Please refer to FIG. 1, FIG. 2A, and FIG. 2B. FIG. 1 is a cross-sectional view of a photonic packaging structure 100 according to a first embodiment of the present disclosure. FIG. 2A is a schematic top view of the photonic packaging structure 100 shown in FIG. 1. FIG. 2B is a schematic bottom view of the photonic packaging structure 100 shown in FIG. 1. The photonic packaging structure 100 includes a substrate 110, a silicon photonic module 120, a light-emitting diode module 130, and a driving element D.

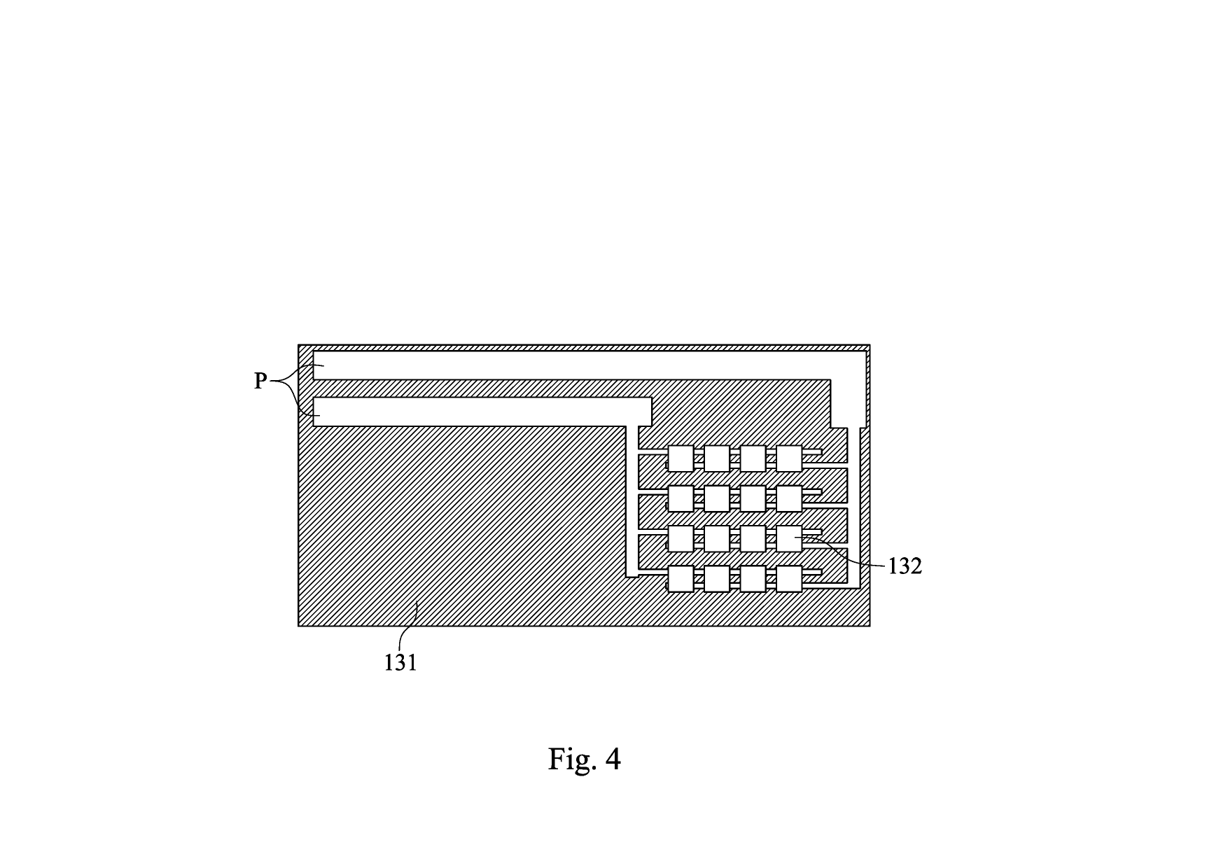

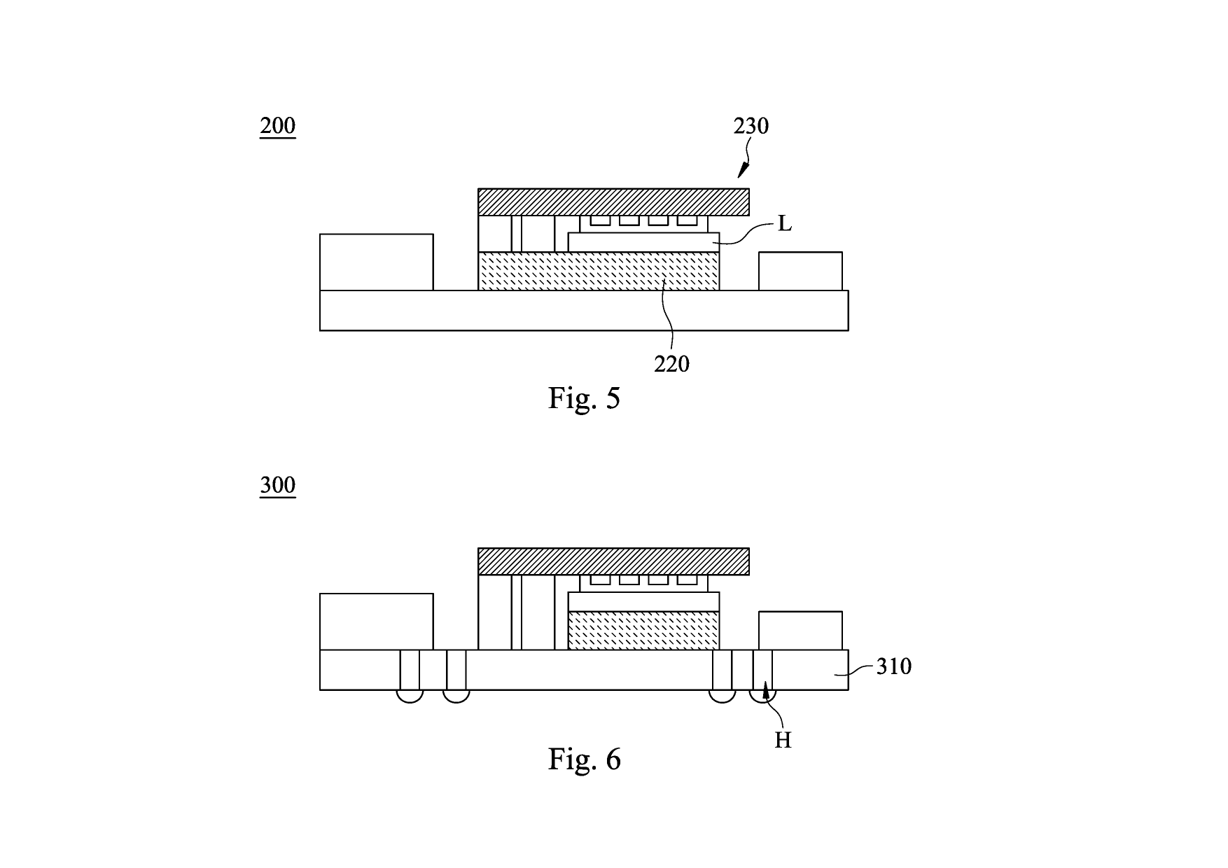

Please refer to FIG. 3A and FIG. 3B. FIG. 3A is a schematic cross-sectional view of the silicon photonic module 120 of the photonic packaging structure 100 shown in FIG. 1, and FIG. 3B is a schematic top view of the silicon photonic module 120 of the photonic packaging structure 100 shown in FIG. 1. The silicon photonic module 120 has a first surface and a second surface opposite to each other. The first surface is connected to the substrate 110. The substrate 110 may be a silicon substrate, an ABF substrate, or a printed circuit board (PCB). Thus, the silicon photonic module 120 can be used to transmit optical signals, thereby improving data transmission and energy efficiency.

The silicon photonic module 120 may include a grating 121, a modulation element 122, a waveguide element 123, and a photo diode 124. The grating 121 may be connected to one end of the waveguide element 123. When light entering the silicon photonic module 120 passes through the grating 121, the amplitude, phase, or other characteristics of the light are affected and altered by the grating 121, and the light enters the waveguide element 123 in a specific state. The modulation element 122 may be coupled to the waveguide element 123 to adjust the amplitude or frequency of the light, allowing the light to carry a specific signal during transmission. The photo diode 124 may serve as a light receiver, receiving the light and emitting a signal. The signal transmitted through the grating 121, the modulation element 122, and the waveguide element 123 may be a transmitting optical signal (Tx), while the signal transmitted by the photo diode 124 may be a receiving optical signal (Rx).

The light-emitting diode module 130 is connected to the second surface of the silicon photonic module 120, such that the silicon photonic module 120 is located between the substrate 110 and the light-emitting diode module 130. By employing the light-emitting diode module 130, the problem of intensity decay or device loss caused by excessive heat generated by the light-emitting module can be mitigated.

The light-emitting diode module 130 includes a carrier 131, at least one light-emitting diode element 132, and at least one conductive bump 133. The light-emitting diode element 132 is disposed on the carrier 131 and faces the silicon photonic module 120. The light-emitting diode element 132 may be aligned with the grating 121 located within the silicon photonic module 120, allowing light emitted from the light-emitting diode module 130 to directly enter and be oriented by the grating 121. Furthermore, the carrier 131 may be a glass carrier, and the light-emitting diode element 132 may be a micro light-emitting diode (micro LED), a sub-millimeter light-emitting diode (mini LED), or an organic light-emitting diode (OLED).

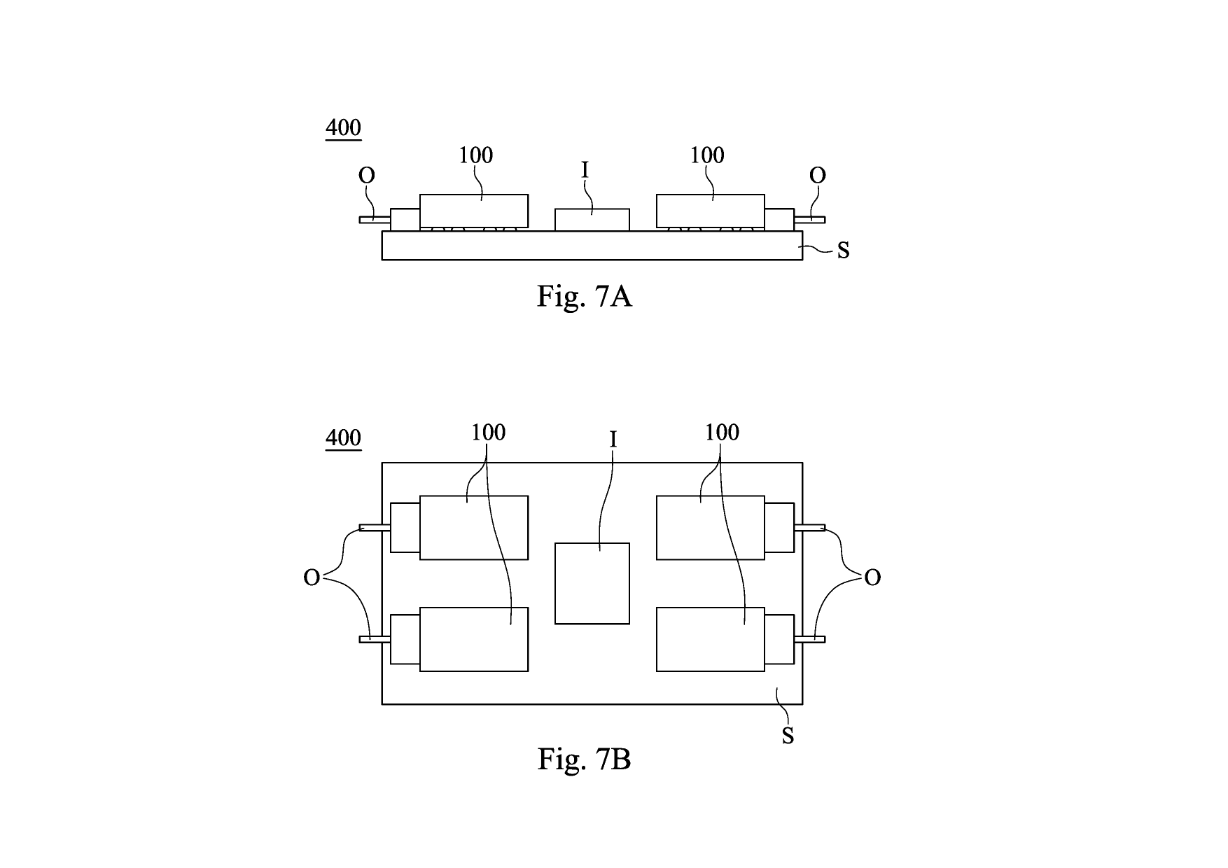

Please refer to FIG. 4, which is a schematic diagram illustrating the arrangement of the light-emitting diode elements 132 in the photonic packaging structure 100 shown in FIG. 1. The number of the light-emitting diode elements 132 may be plural, and the light-emitting diode elements 132 may be electrically connected in parallel. For example, the light-emitting diode elements 132 may be arranged in a matrix on the carrier 131. Two pads P may be provided on the carrier 131 of the light-emitting diode module 130. The pads P are connected to the light-emitting diode elements 132 to form a parallel circuit, thereby increasing the luminous intensity of the light-emitting diode module 130. Furthermore, the light-emitting diode module 130 may further include a protective adhesive layer (not numbered) disposed on the carrier 131, with the light-emitting diode elements 132 embedded within the protective adhesive layer to protect the light-emitting diode elements 132.

It should be noted that the number of the light-emitting diode element 132 may be one or more, depending on the structural design and signal transmission requirements of the silicon photonic module 120. Furthermore, all the light-emitting diode elements 132 can be connected in parallel to simultaneously control the emission of all the light-emitting diode elements 132. Alternatively, the light-emitting diode elements 132 may be divided into multiple groups, each independently connected in parallel to control the emission of a specific region of the light-emitting diode elements 132. In another configuration, the light-emitting diode elements 132 may be electrically connected in series. The present disclosure is not limited to the number or connection method of the light-emitting diode elements 132.

The conductive bumps 133 are disposed on the carrier 131 and face the substrate 110. The conductive bumps 133 are electrically connected to the light-emitting diode elements 132. The driving element D is disposed on the substrate 110 and is electrically connected to the conductive bumps 133. Specifically, the substrate 110 may include at least one connecting bump (not shown), and the conductive bumps 133 may be connected to the connecting bumps. Thus, the light-emitting diode module 130 can be electrically connected to the driving element D through the substrate 110. In other words, the driving element D can be electrically connected to the conductive bumps 133 via the connecting bumps. Alternatively, the silicon photonic module 120 may include a conductive portion (not shown), and the conductive bumps 133 may be connected to the conductive portion. The conductive portion can be pre-established in electrical contact with the driving element D on the substrate 110, allowing the light-emitting diode module 130 to be electrically connected to the driving element D through both the silicon photonic module 120 and the substrate 110. The driving element D may be an application-specific integrated circuit (ASIC), and may be designed according to operational requirements.

The photonic packaging structure 100 may further include at least one optical fiber interface C connected to the silicon photonic module 120 to transmit the optical signal generated by the silicon photonic module 120. Specifically, if the silicon photonic module 120 transmits both a transmitting optical signal generated by the silicon photonic module 120 and a receiving optical signal, two optical fiber interfaces C may be provided—one for transmitting the transmitting optical signal and the other for transmitting the receiving optical signal. However, the number of the optical fiber interfaces C may vary depending on the structural design of the silicon photonic module 120 and the signal transmission requirements, and the present disclosure is not limited in this regard.

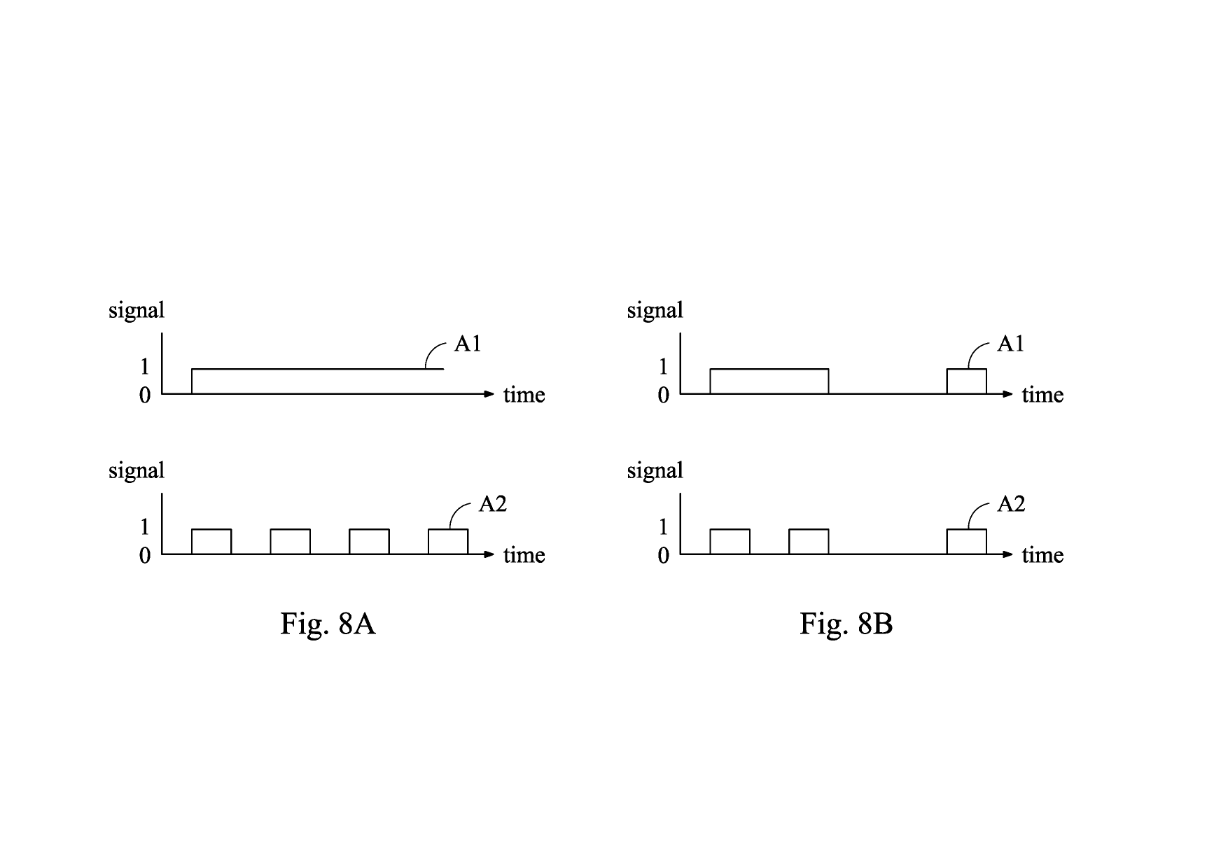

Please refer to FIG. 5, which is a schematic cross-sectional view of a photonic packaging structure 200 according to a second embodiment of the present disclosure. The photonic packaging structure 200 of this embodiment is similar to the photonic packaging structure 100 of the first embodiment, except that the photonic packaging structure 200 further includes a light concentrating element L. The light concentrating element L may have a microlens structure and may be disposed between the silicon photonic module 220 and the light-emitting diode module 230 to adjust the light emitted from the light-emitting diode module 230, thereby achieving effects such as light uniformity, beam shaping, or light coupling.

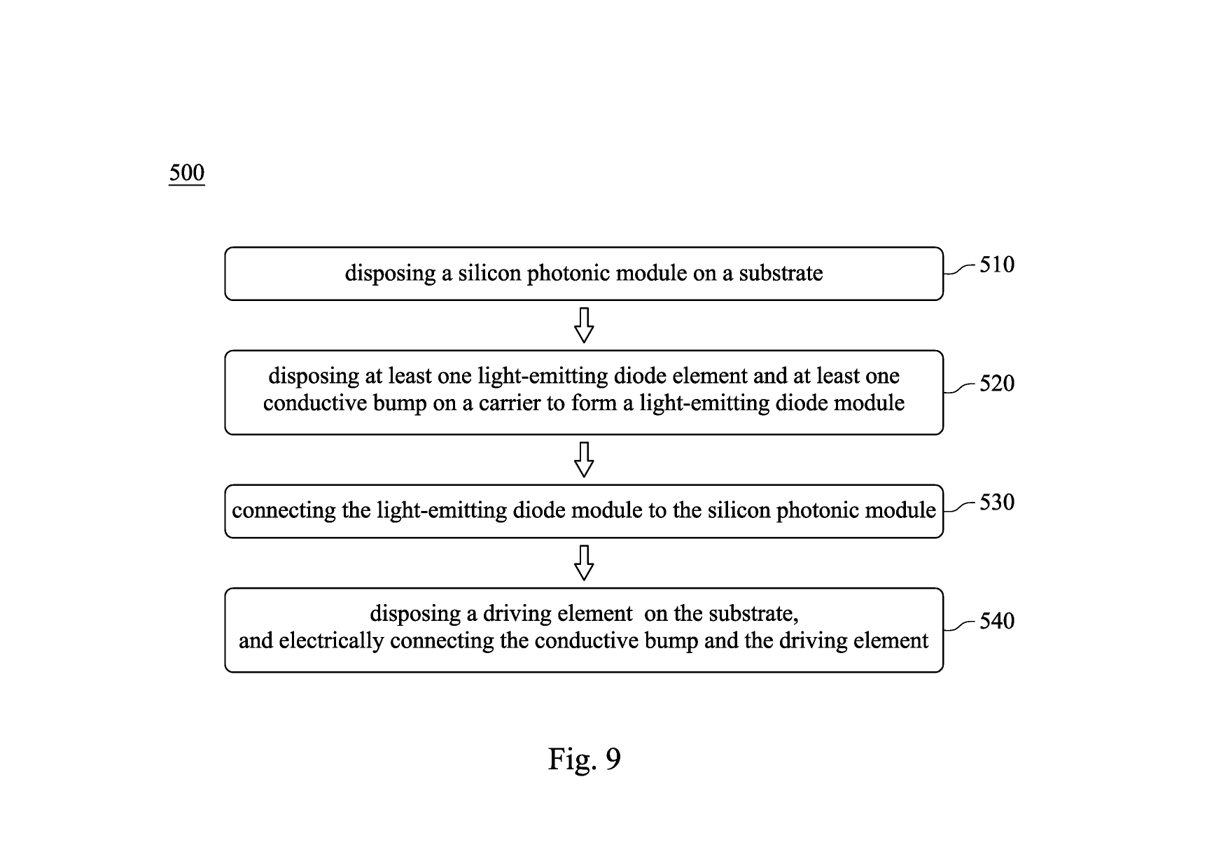

Please refer to FIG. 6, which is a schematic cross-sectional view of a photonic packaging structure 300 according to a third embodiment of the present disclosure. The photonic packaging structure 300 of the third embodiment is similar to the photonic packaging structure 100 of the first embodiment, except that a substrate 310 of the photonic packaging structure 300 is a through-glass via (TGV) substrate having a conductive via H that electrically connects opposite sides of the substrate 310. The conductive via H allows the photonic packaging structure 300 to be vertically stacked with other modules, thereby increasing packaging density and design flexibility.

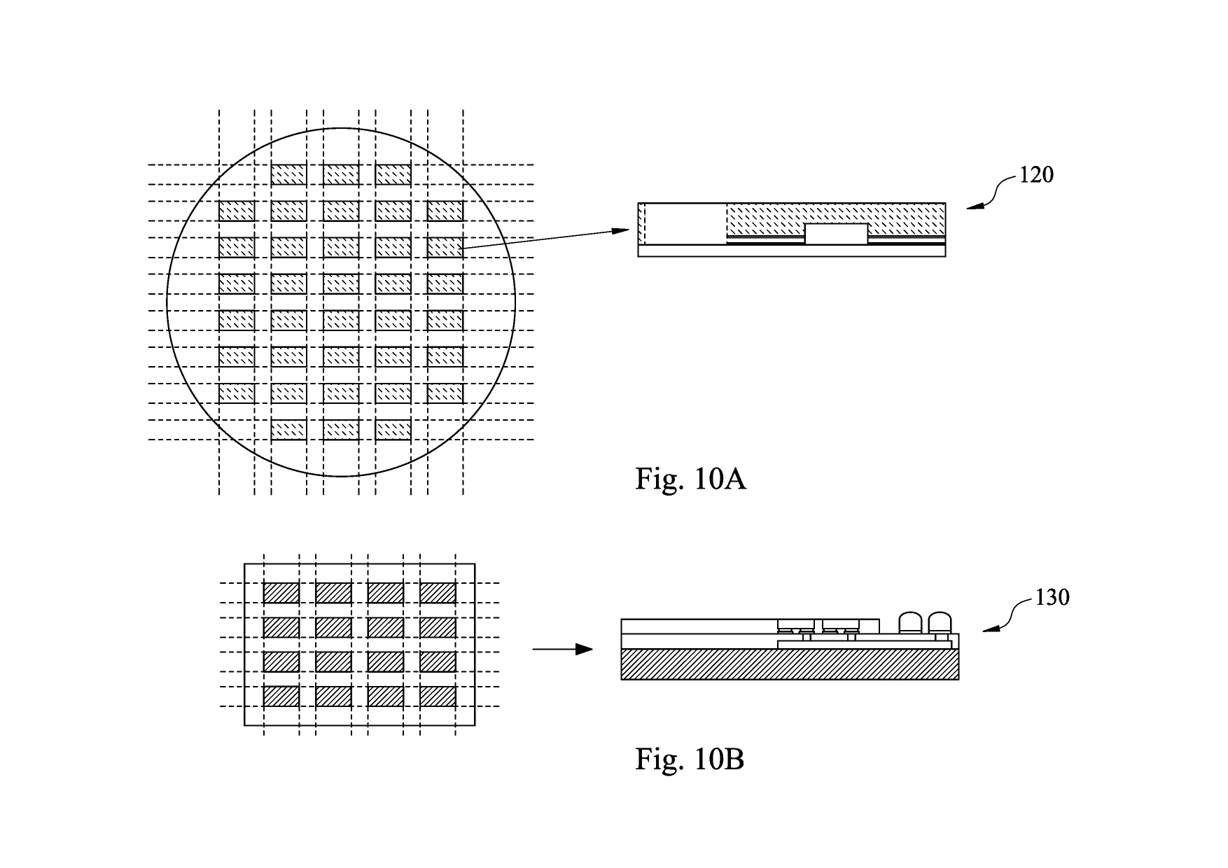

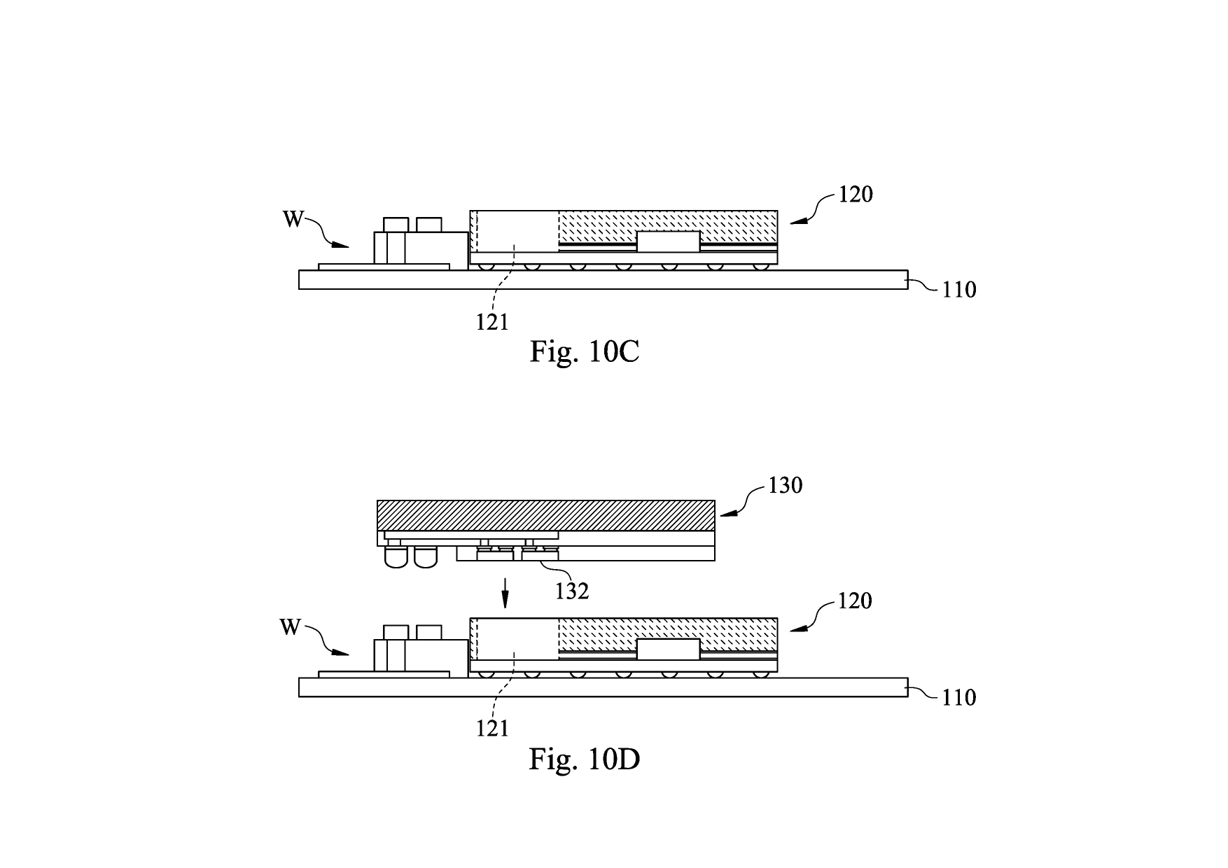

Please refer to FIG. 7A and FIG. 7B. FIG. 7A is a schematic front view of an optical signal switching module 400 according to an embodiment of the present disclosure. FIG. 7B is a schematic top view of the optical signal switching module 400 shown in FIG. 7A. The optical signal switching module 400 includes a control element I, a plurality of photonic packaging structures 100, and a plurality of optical fibers O. While the photonic packaging structures 100 are used as an example in FIGS. 7A and 7B, they may alternatively be the photonic packaging structures 200 or 300, and the present disclosure is not limited in this regard. The control element I and the photonic packaging structures 100 are disposed on a base plate S. The control element I is electrically connected to the photonic packaging structures 100, and the optical fibers O are connected to the optical fiber interfaces C of the photonic packaging structures 100. This arrangement facilitates signal exchange among the multiple photonic packaging structures 100.

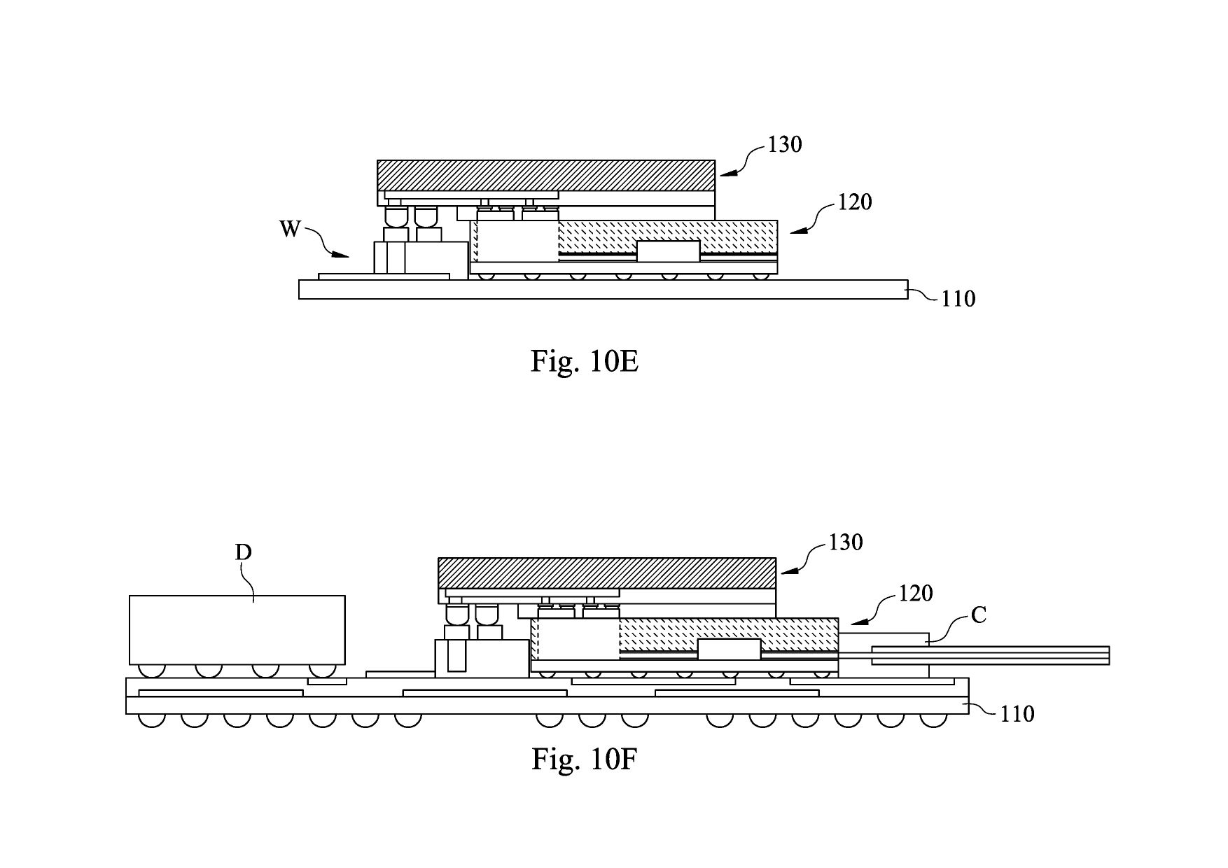

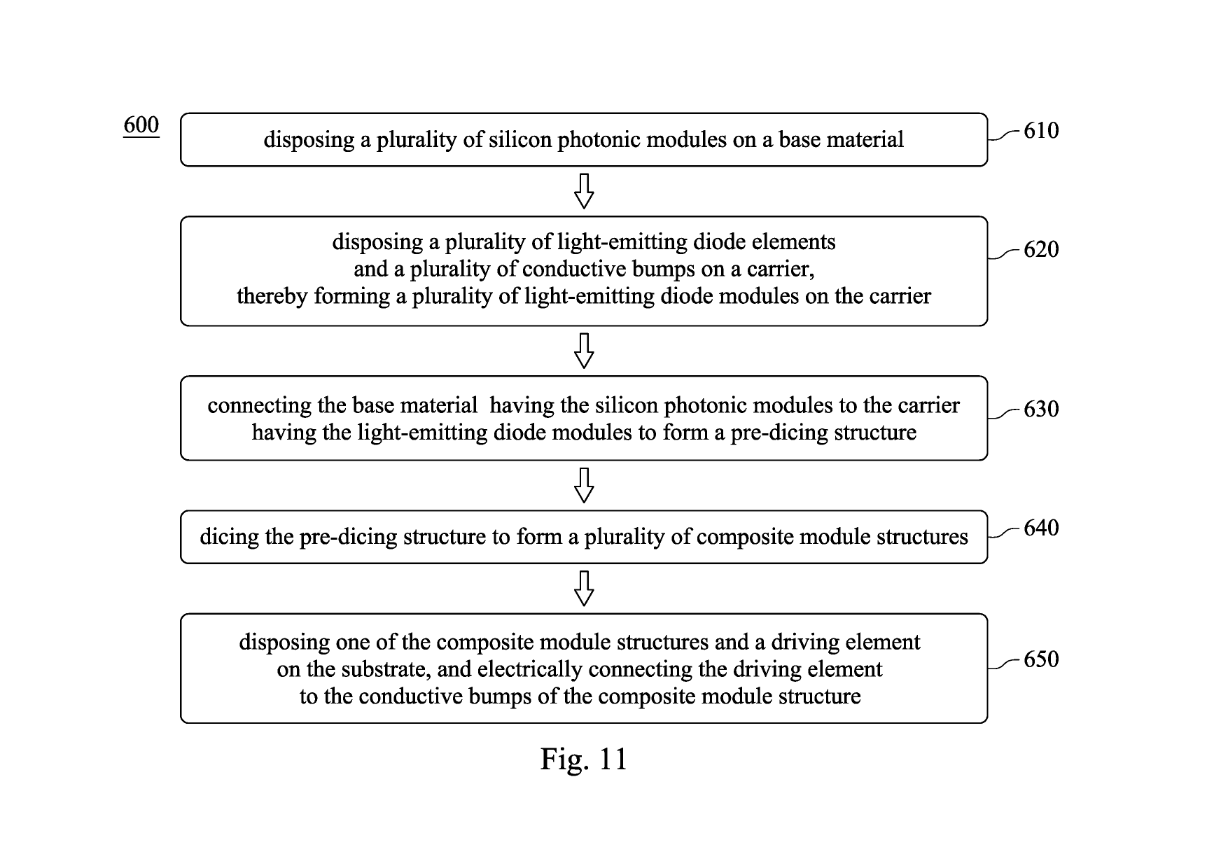

Please refer to FIG. 8A and FIG. 8B. FIG. 8A is a schematic diagram illustrating signal conversion in the photonic packaging structure 100 of the present disclosure, and FIG. 8B is another signal conversion schematic diagram of the same structure. In FIG. 8A, the light-emitting diode module 130 operates in a fixed light source mode. The signal A1 represented by its emitted light is converted by the silicon photonic module 120 to form a regular output signal A2. In FIG. 8B, the light-emitting diode module 130 operates in a variable light source mode. The signal A1 represented by its emitted light can be converted by the silicon photonic module 120 to form an irregular output signal A2. Therefore, the photonic packaging structure 100 of the present disclosure can control the type of output signal by adjusting the light emission mode of the light-emitting diode module 130 and the conversion mode of the silicon photonic module 120.

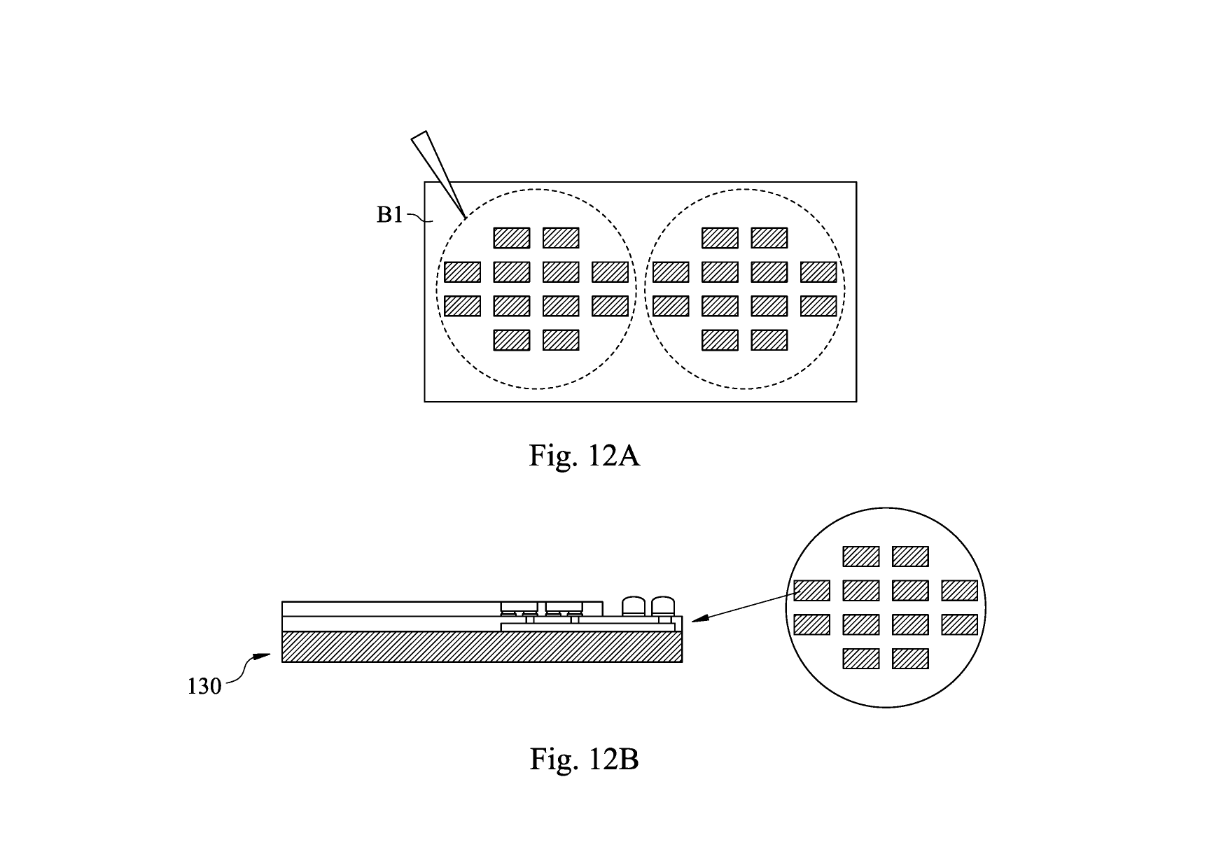

Please refer to FIG. 9, which is a flowchart illustrating a method 500 for manufacturing a photonic packaging structure according to another embodiment of the present disclosure. The method 500 for manufacturing the photonic packaging structure includes steps 510, 520, 530, and 540.

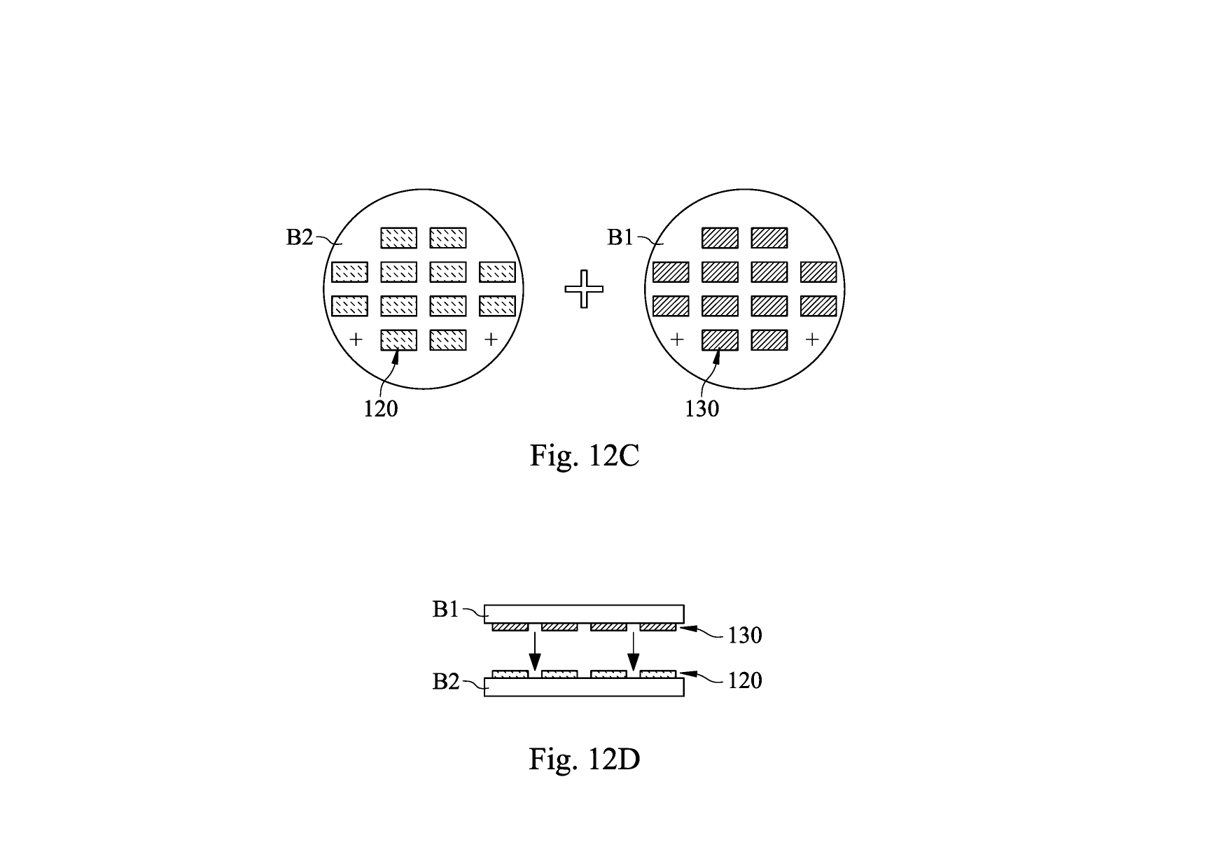

Please refer to FIGS. 10A to 10F. FIGS. 10A to 10F are schematic diagrams showing the respective steps of the method 500 for manufacturing the photonic packaging structure. Step 510 involves disposing a silicon photonic module 120 on a substrate 110. The silicon photonic module 120 has a first surface and a second surface opposite to each other, with the first surface connected to the substrate 110. As shown in FIG. 10A, a plurality of silicon photonic modules 120 may be disposed on a wafer using a mass transfer method and then diced.

Step 520 involves disposing at least one light-emitting diode element 132 and at least one conductive bump (not numbered) on a carrier (not numbered), and electrically connecting the conductive bump to the light-emitting diode element 132 to form a light-emitting diode module 130. Similarly, as shown in FIG. 10B, a plurality of light-emitting diode elements 132 and conductive bumps may be arranged on the carrier using the mass transfer method and then diced to form the light-emitting diode modules 130. A conductive structural layer may be pre-formed on the carrier for circuit arrangement. The conductive structural layer may be made of silicon nitride or silicon oxide. After the light-emitting diode elements 132 and the conductive bumps are placed, the light-emitting diode elements 132 may be encapsulated with an organic compound.

Step 530 involves connecting the light-emitting diode module 130 to the second surface of the silicon photonic module 120, positioning the silicon photonic module 120 between the substrate 110 and the light-emitting diode module 130. The light-emitting diode element 132 of the light-emitting diode module 130 faces the silicon photonic module 120, and the conductive bumps face the substrate 110. Specifically, after completing step 510, the structure shown in FIG. 10C is obtained. Subsequently, the light-emitting diode module 130 and the silicon photonic module 120 are flip-chip aligned and assembled as shown in FIG. 10D. The light-emitting diode element 132 is aligned with a grating 121 in the silicon photonic module 120, and the conductive bumps are aligned with connecting bumps W on the substrate 110, thereby achieving electrical connection and forming the structure shown in FIG. 10E.

The step 540 involves disposing a driving element D on the substrate 110 and electrically connecting the conductive bumps to the driving element D to obtain the photonic packaging structure 100. Additionally, an optical fiber interface C may be disposed on the substrate 110 to form the structure as shown in FIG. 10F. Whether the optical fiber is directly disposed on the substrate 110 depends on the subsequent packaging process, and the present disclosure is not limited in this regard.

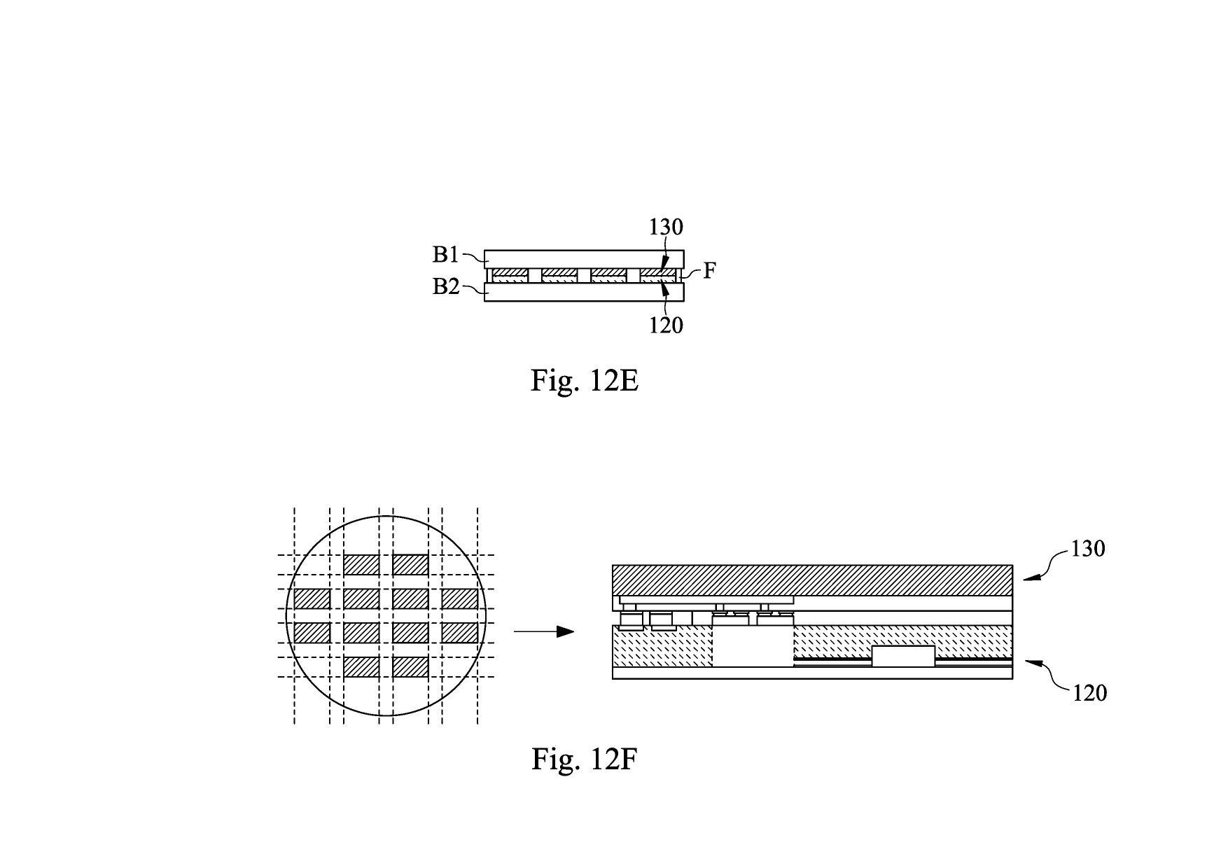

Please refer to FIG. 11, which is a flowchart of a method 600 for manufacturing a photonic packaging structure according to another embodiment of the present disclosure. The method 600 includes steps 610, 620, 630, 640, and 650.

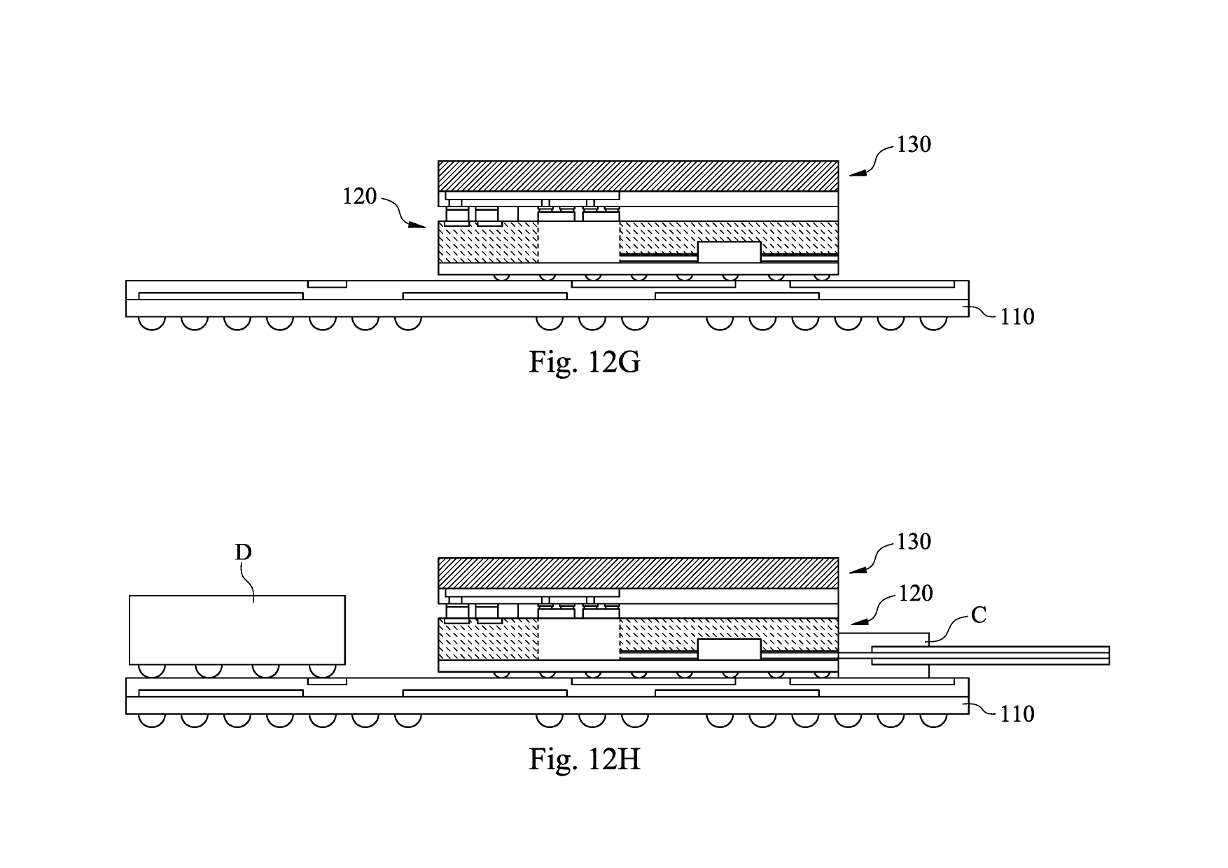

Please refer to FIGS. 12A to 12H, which are schematic diagrams illustrating the respective steps of method 600. Step 610 involves disposing a plurality of silicon photonic modules 120 on a base material B2. Step 620 involves disposing a plurality of light-emitting diode elements (not numbered) and a plurality of conductive bumps (not numbered) on a carrier B1, with the conductive bumps electrically connected to the corresponding light-emitting diode elements, thereby forming a plurality of light-emitting diode modules 130 on the carrier B1. For example, as shown in FIG. 12A, after disposing the light-emitting diode elements and the conductive bumps on the carrier B1, the carrier B1 is diced into smaller plates. As shown in FIG. 12B, each plate may include a plurality of light-emitting diode modules 130, and the shape of the plates may correspond to the base material B2 of the silicon photonic modules 120 to facilitate subsequent assembly.

Step 630 involves connecting the base material B2 having the silicon photonic modules 120 to the carrier B1 having the light-emitting diode modules 130, so that the silicon photonic modules 120 and the light-emitting diode modules 130 are located between the base material B2 and the carrier B1. The light-emitting diode modules 130 are respectively connected to the corresponding silicon photonic modules 120 to form a pre-dicing structure, wherein the light-emitting diode elements of the light-emitting diode modules 130 face the silicon photonic modules 120, and the conductive bumps face the base material B2. Specifically, as shown in FIG. 12C, the base material B2 and the carrier B1 include alignment marks (cross marks), which can be calibrated and aligned using optical instruments. Then, as shown in FIGS. 12D and 12E , the base material B2 and the carrier B1 are stacked in a wafer-on-wafer manner, and a filler F is then filled between the base material B2 and the carrier B1 to protect the silicon photonic modules 120 and the light-emitting diode modules 130.

Step 640 involves dicing the pre-dicing structure to form a plurality of composite module structures, as shown in FIG. 12F. Step 650 involves disposing one of the composite module structures on a substrate 110, as shown in FIG. 12G. A driving element D is disposed on the substrate 110 and electrically connected to the conductive bumps of the composite module structure. An optical fiber interface C may also be disposed on the substrate 110 to obtain the photonic package structure 100, as shown in FIG. 12H.

According to the foregoing embodiments of the present disclosure, the photonic packaging structure disclosed herein utilizes a light-emitting diode module which provides a stable and efficient light-emitting effect. This design helps prevent temperature rise within the photonic packaging structure, reduces problems such as light intensity attenuation or structural damage caused by high temperatures, and thereby extends the service life of the photonic packaging structure.

Although the present invention has been described in considerable detail with reference to certain embodiments, other embodiments are also possible. Therefore, the spirit and scope of the appended claims should not be limited to the specific embodiments described herein.

It will be apparent to those skilled in the art that various modifications and variations can be made to the structure of the present invention without departing from the scope or spirit of the invention. Accordingly, it is intended that the present invention cover all such modifications and variations, provided they fall within the scope of the following claims.

What is claimed is:

1. A photonic packaging structure, comprising:
a substrate;
a silicon photonic module having a first surface and a second surface opposite to each other, the first surface being connected to the substrate;
a light-emitting diode module connected to the second surface of the silicon photonic module such that the silicon photonic module is located between the substrate and the light-emitting diode module, wherein the light-emitting diode module comprises:
a carrier;
at least one light-emitting diode element disposed on the carrier, the at least one light-emitting diode element facing the silicon photonic module; and
at least one conductive bump disposed on the carrier, the at least one conductive bump facing the substrate and electrically connected to the at least one light-emitting diode element; and
a driving element disposed on the substrate and electrically connected to the at least one conductive bump.

2. The photonic packaging structure of claim 1, wherein the silicon photonic module comprises a grating, and the at least one light-emitting diode element is aligned with the grating.

3. The photonic packaging structure of claim 2, wherein the silicon photonic module further comprises a modulation element and a waveguide element, the modulation element being coupled to the waveguide element, and the waveguide element being connected to the grating.

4. The photonic packaging structure of claim 1, wherein the number of the at least one light-emitting diode element is plural, and the light-emitting diode elements are electrically connected in parallel.

5. The photonic packaging structure of claim 4, further comprising two pads disposed on the carrier of the light-emitting diode module, and the two pads being connected in parallel to the light-emitting diode elements.

6. The photonic packaging structure of claim 1, wherein the substrate comprises at least one connecting bump, and the at least one conductive bump is connected to the at least one connecting bump.

7. The photonic packaging structure of claim 1, wherein the at least one conductive bump is electrically connected to the silicon photonic module.

8. The photonic packaging structure of claim 1, further comprising at least one optical fiber interface connected to the silicon photonic module.

9. The photonic packaging structure of claim 1, further comprising a light concentrating element disposed between the silicon photonic module and the light-emitting diode module.

10. The photonic packaging structure of claim 1, wherein the substrate comprises a conductive via, and the conductive via electrically connects two opposite sides of the substrate.

11. A method for manufacturing a photonic packaging structure, comprising:
disposing a silicon photonic module on a substrate, wherein the silicon photonic module has a first surface and a second surface opposite to each other, and the first surface is connected to the substrate;
disposing at least one light-emitting diode element and at least one conductive bump on a carrier, and electrically connecting the at least one conductive bump to the at least one light-emitting diode element to form a light-emitting diode module;
connecting the light-emitting diode module to the second surface of the silicon photonic module such that the silicon photonic module is located between the substrate and the light-emitting diode module, wherein the at least one light-emitting diode element of the light-emitting diode module faces the silicon photonic module, and the at least one conductive bump faces the substrate; and
disposing a driving element on the substrate, and electrically connecting the at least one conductive bump to the driving element to obtain the photonic packaging structure.

12. The method for manufacturing the photonic packaging structure of claim 11, wherein the substrate comprises at least one connecting bump, and the driving element is electrically connected to the at least one conductive bump via the at least one connecting bump.

13. A method for manufacturing a photonic packaging structure, comprising:
disposing a plurality of silicon photonic modules on a base material;
disposing a plurality of light-emitting diode elements and a plurality of conductive bumps on a carrier, wherein the conductive bumps are electrically connected to the corresponding light-emitting diode elements, thereby forming a plurality of light-emitting diode modules on the carrier;
connecting the base material having the silicon photonic modules to the carrier having the light-emitting diode modules such that the silicon photonic modules and the light-emitting diode modules are located between the base material and the carrier, and the light-emitting diode modules are respectively connected to the corresponding silicon photonic modules to form a pre-dicing structure, wherein the light-emitting diode elements of the light-emitting diode modules face the silicon photonic modules, and the conductive bumps face the base material;
dicing the pre-dicing structure to form a plurality of composite module structures; and
disposing one of the composite module structures and a driving element on a substrate, and electrically connecting the driving element to the conductive bump of the one composite module structure to obtain the photonic packaging structure.

14. The method for manufacturing the photonic packaging structure of claim 13, wherein the conductive bump of each of the light-emitting diode modules is electrically connected to the silicon photonic modules.

15. The method for manufacturing the photonic packaging structure of claim 13, wherein a filler is disposed between the base material and the carrier before dicing the pre-dicing structure.
